(19) United States
(12) Patent Application Publication
(10) Pub. No.: US 2008/0174908 A1
(43) Pub. Date: Jul. 24, 2008

(54) Adaptive temperature and altitude compensation for writing on disk drives

(75) Inventor: Richard Wang, Fremont, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/657,190

(22) Filed: Jan. 23, 2007

(51) Int. Cl. G11B 33/14

(52) U.S. Cl. 360/97.02

(57) ABSTRACT

A hard disk drive that performs a write verify routine to determine optimal write parameters for the heads of the drive. The write verify routines are performed until a successful write operation has occurred. The write verify routine is disabled if there has been a predetermined number of previously acceptable write operations.

### BACKGROUND OF THE INVENTION

1. Field of the Invention

The present invention relates to a method for writing data onto a disk of a hard disk drive.

2. Background Information

Hard disk drives contain a plurality of magnetic heads that are coupled to rotating disks. The heads can magnetize and sense the magnetic fields of the disks to write and read data, respectively. The heads are coupled to a pivoting actuator arm that has a voice coil motor. The disks are rotated by a spindle motor of the drive.

Data is typically stored on tracks that extend radially across the disk surfaces. The voice coil motor can be energized to pivot the actuator arm and move the heads to different track locations. Each track is typically divided into a number of sectors. Each sector contains at least one data field. Data is typically written onto a number of sectors during a write operation of the drive.

Each head has an air bearing surface. The rotating disks generate a flow of air that cooperates with the air bearing surface to create an air bearing between a head and the adjacent disk surface. The air bearing eliminates or minimizes mechanical contact between the head and the disk.

The disks are magnetized and data is written with a magnetic field that emanates from the heads. The magnetic field is created by providing a current to a coil that is embedded into the head. Magnetization of the disks is a function of the height of the air bearing. A taller air bearing will produce a weaker magnetic field and vice versa.

The height of each air bearing is a function of the air within the drive. The air is a function of temperature and altitude. For example, the air bearing will become larger with a decrease in temperature and a decrease in altitude.

There are a number of parameters associated with writing data onto a disk. By way of example, there are write current, overshoot control, and pre-compensation parameters associated with each write channel of the drive. These parameters are typically stored in the disk drive and retrieved each time the drive is booted up.

Ideally, to compensate for varying temperatures and altitudes the disk drives are calibrated in a temperature and altitude simulation chamber to determine the optimum write parameters for different temperature and atmospheric conditions. The different write parameters are stored in a table before shipping the disk drive from a manufacturing facility. When the drive boots up, the temperature and altitude are sensed and the corresponding write parameters are pulled from memory.

Unfortunately, it is not economically feasible to test every single disk drive in temperature and altitude simulation chambers in the manufacturing facility. The equipment and energy cost would significantly add to the final cost of each disk drive. In addition, such test chambers would be difficult to manage on a large scale since such equipment is complex and breaks down easily. Currently, all drives are tested at near sea level at room temperature.

There have been developed write verify routines in disk drives while the drive is operating in the field. Write verify routines write data to the media and read the data back to verify the write is good. If the data cannot be read back, write and read will be repeated until the data can be read back. Each time the write parameters will be varied to improve the chance of making a good write. Having to perform write verify routines during normal operation can degrade the performance of the disk drive.

### BRIEF SUMMARY OF THE INVENTION

A hard disk drive with a head that writes data to a disk with at least one write parameter. The disk drive includes a controller coupled to the head and a temperature sensor.

### BRIEF DESCRIPTION OF THE DRAWINGS

FIG. 1 is a top view of an embodiment of a hard disk drive;

FIG. 2 is a schematic of an electrical circuit for the hard disk drive;

FIG. 3 is a flow chart showing a write verify routine performed by the disk drive.

### DETAILED DESCRIPTION

Disclosed is a hard disk drive that performs a write verify routine to determine optimal write parameters for the heads of the drive. The write verify routines are performed until a successful write operation has occurred. The write verify routine is disabled if there has been a predetermined number of previously acceptable write operations. Disabling the write verify routine eliminates unnecessary write verify routines that will degrade the performance of the disk drive.

Upon boot up of the hard disk drive, the disk controller will sense the temperature and altitude and select a cell from the temperature and altitude compensation and control (TACC) table where the write parameter adjustment values are stored. After the boot up routine, the drive will accept and execute customer commands immediately to minimize start-up delay. At this point, every write command will go through the write verify process to ensure that all writes are good.

During the write verify process, if rewrites are required, the final varied write parameter values after the write verify process will be used to calibrate the values in the selected cell in the TACC table. The “no rewrite” counter will also be cleared to 0. If no rewrite is required for N number of writes in a row, write verify will be disabled and all subsequent writes will not be verified to improve drive performance. N is a preset number used to determine the confidence level that the write parameters can perform good writes without verification.

The TACC table contains a cell for many temperature and altitude ranges. In some cases, altitude ranges may not be needed if there are other methods to compensate for altitude. For each cell in a temperature and altitude range, there are many sets of adjustment factors for all write parameters. Each head and data zone range has its own set so that different heads and different data zone ranges can have different adjustment factors. Data zones are used to simplify managing disk radius by quantizing disk radius into discrete ranges where all tracks in the same range will be treated the same.

An advantage of the TACC table with adaptive capability is that the temperature and altitude sensor only need to be consistent, but does not need to be accurate. As long as the drive always select the same cell for the same temperature and altitude condition, the cell will be calibrated to the correct write parameter for that temperature and altitude.

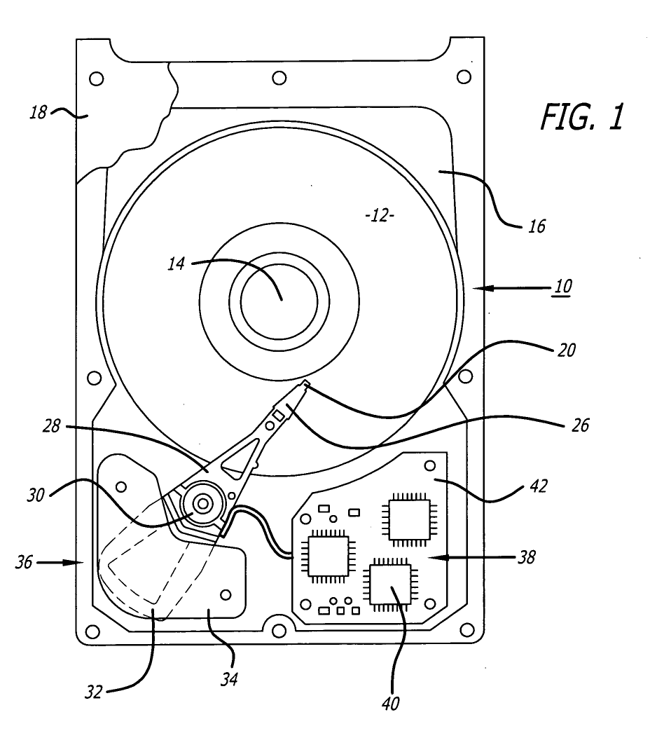

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. Each head 20 may have separate write (not shown) and read elements (not shown). The heads 20 are gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

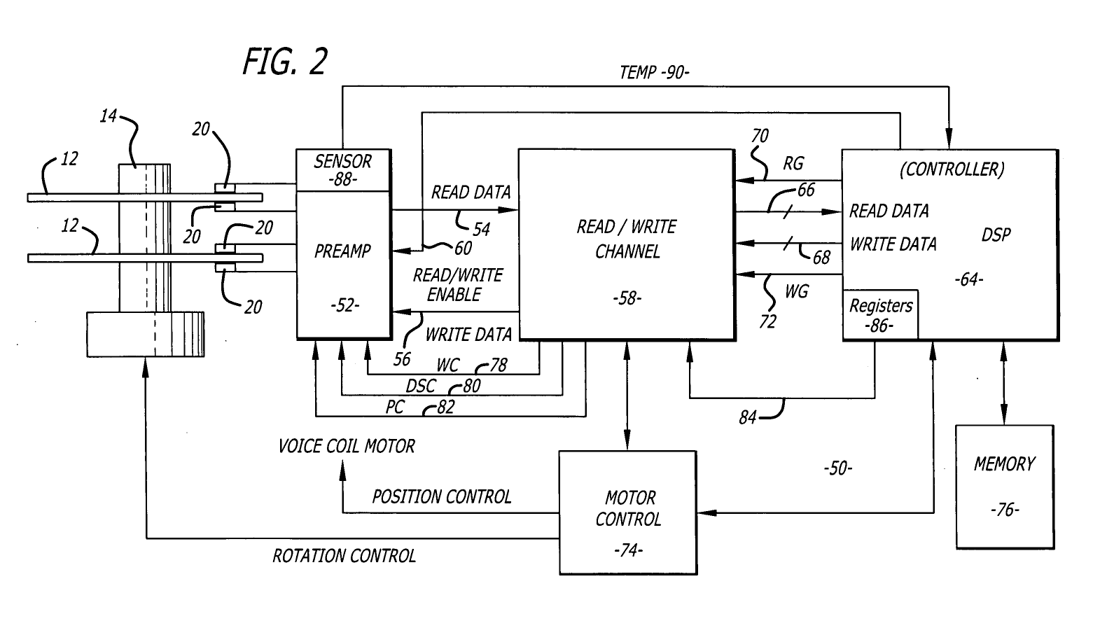

FIG. 2 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a firmware and/or software routine, including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”).

The pre-amp 52 typically has a number of different write characteristics such as write current, overshoot control and pre-compensation. The values of these characteristics can be set through write current Wc 78, overshoot control OSC 80 and pre-compensation Pc 82 lines. The values may be set by the read/write channel circuit 58. The read/write channel circuit 58 may obtain the values from the controller 64 through line 84. The variable write parameters may be stored in registers 86.

The pre-amplifier 52 may include a temperature sensor 88. The temperature sensor 88 can sense the temperature of the drive. The sensor 88 may provide a measured temperature signal to the controller 64 on TEMP line 90. The controller 64 can set one or more of the variable write parameters like Wc, OSC and Pc in accordance with the measured temperature. The write parameters can also be a function of altitude. The write parameters may be arranged in cells defined by temperature, altitude and data zones and stored in memory of the drive. By way of example, the data may be stored on the disk. The write parameters can be stored in a table or formula form that is commonly referred to as temperature and altitude control and compensation (“TACC”). Because expensive equipment that are complex to manage is required to provide temperature and altitude simulation chambers to calibrate the TACC, the TACC is initialized with best guess values that may not be accurate enough to provide good quality writes. Since every head, disk, pre-amplifier, and channel are slightly different, it is difficult to find a TACC that will work for all cases.

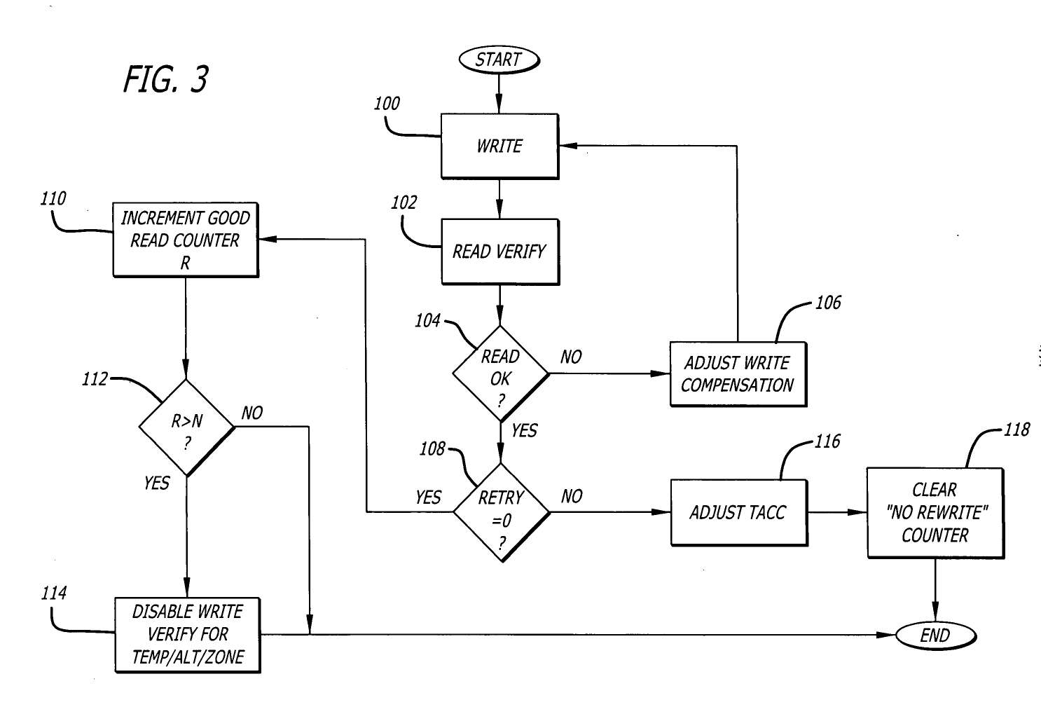

When the disk drive 10 is booted up in the field the drive may sense the temperature through the sensor 88. The altitude may be determined by reading a signal from the disk. The signal strength can provide an indication of the altitude. If the temperature and altitude fall within one of the TACC cell's temperature and altitude range, then the drive uses the write parameters in that cell. The cell should have a set of write parameters for each head and data zone range. This will allow the drive to have different write parameters for each head and data zone ranges which may require different write parameters. Since the TACC cannot be calibrated in the factory due to high cost of test equipment and complexity of managing the testers, the TACC is calibrated on the field by using write verify. FIG. 3 is a flowchart for a write verify routine for a head of the disk drive. A separate routine may be performed for each head and each data zone range of the drive. In step 100 the head writes a signal onto a disk. The signal is read back in step 102. Decision block 104 determines whether the write operation produced a satisfactory signal. If not, one or more of the write parameters are adjusted in step 106 and the process is repeated.

Once the write verify operation is successful then decision block 108 determines whether the number of retries was zero. If the number of retries was zero then the “no rewrite” counter is incremented in step 110. In decision block 112 it is determined whether the “no rewrite” counter value R is greater than a predetermined value N. If R is greater than N, then the write verify routine for the corresponding head, data zone range, temperature, and altitude is disabled in block 114. The predetermined value can be a number where there is a high confidence level that the write parameters will produce successful write operations without retries or verification. Disabling the write verify routine eliminates the need to continue unnecessary reads and writes which can degrade the performance of a disk drive.

If the number of retries is not zero then the process proceeds to block 116 where the final write parameter will be used to calibrate the TACC. The write parameters can be adjusted in accordance with the following equation:

F_{new}=μ(F_{adapted}−Fₚᵣₑᵥᵢₒᵤₛ)+Fₚᵣₑᵥᵢₒᵤₛ (1)

μ is an adaptation rate. By way of example, μ may be 0.1 or 0.2. F can be any of the write parameters being adjusted. The “no rewrite” counter is cleared in block 118 to insure that the counter counts consecutive zero retry write operations.

The write verify process will continue until all heads, data zone ranges, temperature, and altitude have been calibrated. Each head, data zone range, temperature, and altitude should maintain its own “no rewrite” counter and write parameters so each can be calibrated separately. Some drives may never encounter all temperature and altitude ranges and may never write to all heads and data zones. That is OK since the drive only need good write parameters for the heads, data zones, temperature, and altitude where the drive operates.

The TACC can be saved to the disk for future use so that the write verify operation can be skipped to improve drive performance in future use. The TACC can also be reset to factory condition after certain number of hours of operation to account for changes in head and media characteristics over time.

With the use of write verify and TACC with adaptive capability, the temperature and altitude sensors only need to be consistent, but does not need to be accurate. If the temperature and altitude sensors are inaccurate and caused the drive to pick the wrong TACC cell, as long as the same cell is always selected for the same condition, that cell will be calibrated with the write parameters for the current temperature and altitude. The drive will still be able to read and write properly even though it is using the write parameters from the wrong cell.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a housing;
a disk;
a spindle motor that rotates said disk;
a head coupled to said disk, said head writes data onto said disk in accordance with at least one write parameter;
an actuator arm coupled to said head;
a voice coil motor coupled to said actuator arm;
a temperature sensor that senses a drive temperature; and,
a controller coupled to said head and said temperature sensor, after boot up of the hard disk drive said controller performs a write verify routine for all user write commands to ensure all writes are good, if said write verify routine is not satisfactory said controller varies said write parameter to compensate for the disk temperature and altitude of the hard disk drive and performs another write verify routine, said controller continues to vary said write parameter and performs a write verify routine until a successful write verify routine is performed, said controller disables said write verify routine if a predetermined number of consecutive successful write verify routines have been achieved.

2. The disk drive of claim 1, wherein said controller utilizes a write parameter established during a testing process of the hard disk drive.

3. The disk drive of claim 2, wherein said write verify routines relate to a cell defined by a temperature, an altitude and a data zone of the hard disk drive.

4. The disk drive of claim 1, wherein said write parameter includes at least one of a write current, an overshoot control and a pre-compensation.

5. The disk drive of claim 1, further comprising a plurality of heads and said controller performs write verify routines for each head.

6. A hard disk drive, comprising:
a housing;
a disk;
a spindle motor that rotates said disk;
a head coupled to said disk, said head writes data onto said disk in accordance with at least one write parameter;
an actuator arm coupled to said head;
a voice coil motor coupled to said actuator arm;
a temperature sensor that senses a drive temperature; and,
controller means for performing a write verify routine upon a boot up of the hard disk drive, if said write verify routine is not satisfactory said controller means varies said write parameter to compensate for the disk temperature and altitude of the hard disk drive and performs another write verify routine, said controller means continues to vary said write parameter and performs a write verify routine until a successful write verify routine is performed, said controller means disables said write verify routine if a predetermined number of successful write verify routines have been achieved.

7. The disk drive of claim 6, wherein said controller means utilizes a write parameter established during a testing process of the hard disk drive.

8. The disk drive of claim 7, wherein said write verify routines relate to a cell defined by a temperature, an altitude and a data zone of the hard disk drive.

9. The disk drive of claim 6, wherein said write parameter includes at least one of a write current, an overshoot control and a pre-compensation.

10. The disk drive of claim 6, further comprising a plurality of heads and said controller means performs write verify routines for each head.

11. A method for writing data onto a disk of a hard disk drive, comprising:
booting up a hard disk drive;
sensing a temperature of the hard disk drive;
performing a write verify routine on a head of the hard disk drive for all write commands from user;
varying a write parameter if the write verify routine is not satisfactory, to compensate for the temperature and an altitude of the hard disk drive;
performing additional write verify routines and varying the write parameter until a successful write verify routine is performed; and,
disabling the write verify routine if a predetermined number of successful write verify routines have been achieved.

12. The method of claim 11, further comprising establishing the write parameter during a testing process of the hard disk drive.

13. The method of claim 11, wherein the write verify routines relate to a cell defined by a temperature, an altitude and a data zone of the hard disk drive.

14. The method of claim 11, wherein the write parameter includes at least one of a write current, an overshoot control and a pre-compensation.

15. The method of claim 11, wherein the hard disk drive includes a plurality of heads and write verify routines are performed for each head.
